(19) United States
(12) Patent Application Publication
(10) Pub. No.: US 2013/0317165 A1
(43) Pub. Date: Nov. 28, 2013

(54) CROSSLINKED RESIN FINE PARTICLE AND COATING COMPOSITION

(71) Applicants: Sachiko MORIMOTO, Osaka (JP); Hirofumi YAMASHITA, Osaka (JP); Naoya YABUUCHI, Osaka (JP)

(72) Inventors: Sachiko MORIMOTO, Osaka (JP); Hirofumi YAMASHITA, Osaka (JP); Naoya YABUUCHI, Osaka (JP)

(21) Appl. No.: 13/895,556

(22) Filed: May 16, 2013

(30) Foreign Application Priority Data
May 28, 2012 (JP) 2012-120847
Oct. 12, 2012 (JP) 2012-226569

(51) Int. Cl. C09D 133/26

(52) U.S. Cl. CPC C09D 133/26
USPC 524/555; 526/304

(57) ABSTRACT

The object of the present disclosure is to provide a crosslinked resin fine particle which has a particle diameter small enough to be used suitably for the purpose of viscosity control and can be produced inexpensively. Crosslinked resin fine particles obtained by reacting a vinyl monomer composition comprising:
5 to 50% by weight of a (meth)acrylamide-based monomer (A),
5 to 50% by weight of a crosslinkable unsaturated monomer (B), and
10 to 90% by weight of a (meth)acrylate having an alkyl group containing 8 to 24 carbon atoms (C) in an organic solvent, and having a number average particle diameter of 10 to 250 nm.

This application claims priority to Japanese Patent Application No. 2012-120847, filed May 28, 2012, and Japanese Patent Application No. 2012-226569, filed Oct. 12, 2012, the contents of which are incorporated herein by reference.

### TECHNICAL FIELD

The present disclosure relates to crosslinked resin fine particles and coating compositions.

### BACKGROUND OF THE DISCLOSURE

In the field of coating, the viscosity control of a solvent based coating composition has been considered as an important goal for the purpose of preventing sagging at the time of coating or preventing mixing with another layer. In order to control such viscosity, incorporation of a crosslinked resin fine particle has been performed (for example, patent document 1). For controlling of viscosity, such a crosslinked resin fine particle is required to be insoluble in a solvent with which the fine particle is present together. Moreover, it is also required to be capable of being dispersed well in a coating solvent. Furthermore, in the case of incorporating it in a clear coating, it is possible to improve the transparency of a coating film by reducing the particle diameter.

However, regarding the crosslinked resin fine particle disclosed in patent document 1, a resin fine particle obtained via non-aqueous dispersion polymerization is poor in viscosity controlling ability and it is difficult to reduce the particle diameter as much as the transparency of a clear coating film can be maintained. On the other hand, a fine particle obtained via emulsion polymerization can have a small particle diameter, but replacing the water to an organic solvent is needed to disperse it in a solvent based paint, and therefore it has a problem that the production cost is likely to become high. Furthermore, the effect of controlling viscosity is not necessarily sufficient. Therefore, a crosslinked resin fine particle having a better ability to control the viscosity and can be produced inexpensively has been demanded.

Patent document 2 discloses a crosslinked resin fine particle obtained via non-aqueous dispersion polymerization using a (meth)acrylamide type monomer and a monomer having two or more polymerizable double bonds. However, the crosslinked resin fine particle disclosed in this document is one to be used for forming a hydrophilic film and is not for viscosity control. Moreover, the crosslinked resin fine particle disclosed in patent document 2 is poor in dispersibility into an organic solvent-based coating and particles thereof flocculate together in a coating. Therefore, it has a problem that it is unsuitable for viscosity control of an organic solvent-based coating.

Patent document 3 discloses a crosslinked resin fine particle obtained using a (meth)acrylamide type monomer and a monomer having a N-methylol group or a N-alkoxymethyl group. However, the crosslinked resin fine particle disclosed in this document is one to be used for forming a hydrophilic film and is not for viscosity control. Moreover, the crosslinked resin fine particle disclosed in patent document 3 is strongly hydrophilized on its particle surface because of the use of a hydrophilic macromonomer in a large amount. For this reason, resin particles flocculate together in an organic solvent-based coating and therefore, in term of dispersibility, it is difficult to apply the crosslinked resin fine particle to a solvent-based coating.

### PRIOR TECHNICAL DOCUMENT

### Patent Document

[Patent Document 1] JP-A-05-111671
[Patent Document 2] JP-A-08-003251
[Patent Document 3] JP-A-08-120003

### SUMMARY OF INVENTION

### Problem to be Solved by the Invention

In view of the above-described circumstances, an object of the present disclosure is to provide a crosslinked resin fine particle that has a number average particle diameter of 10 to 250 nm which can be used suitably for the purpose of viscosity control and can be produced inexpensively, and a coating composition comprising the same. Particularly, the object is to provide crosslinked resin particles having a number average particle diameter of 10 to 250 nm and a coloring coating composition comprising the same, crosslinked resin particles having a number average particle diameter of 10 to 100 nm and a clear coating composition comprising the same.

### Means for Solving Object

The present disclosure relates to crosslinked resin fine particles obtained by reacting a vinyl monomer composition comprising 5 to 50% by weight of a (meth)acrylamide-based monomer (A), 5 to 50% by weight of a crosslinkable unsaturated monomer (B), and 10 to 90% by weight of a (meth)acrylate having an alkyl group containing 8 to 24 carbon atoms (c) in an organic solvent.

It is preferable that the (meth)acrylamide-based monomer (A) is at least one monomer selected from the group consisting of (meth)acrylamide, N-methyl(meth)acrylamide, N-ethyl(meth)acrylamide, N-propyl(meth)acrylamide, N-butyl(meth)acrylamide, N,N-dimethyl(meth)acrylamide, N,N-diethyl(meth)acrylamide, N,N-dipropyl(meth)acrylamide, and N,N-dibutyl(meth)acrylamide.

It is preferable that the crosslinkable unsaturated monomer (B) is at least one monomer selected from the group consisting of N-methylol(meth)acrylamide and N-alkoxymethyl(meth)acrylamides.

It is preferable that the (meth)acrylate (C) is at least one monomer selected from compounds having a straight alkyl group containing 10 to 20 carbon atoms.

The vinyl monomer composition may be one comprising a monomer (D) other than the (A), the (B), and the (C).

It is preferable that the vinyl monomer composition comprise a hydroxyl group-containing vinyl monomer (D-1) as the monomer (D) other than the (A), the (B), and the (C).

It is preferable that the vinyl monomer composition comprise a carboxylic acid group-containing vinyl monomer (D-2) as the monomer (D) other than the (A), the (B), and the (C).

It is preferable that the crosslinked resin fine particles have a number average particle diameter of 10 to 250 nm, and in the case of a clear coating where transparency is particularly required, the number average particle diameter is preferably 10 to 100 nm, and more preferably 10 to 50 nm. The present disclosure also is a coating composition comprising any of the above-described crosslinked resin fine particles.

### Effect of the Invention

The crosslinked resin fine particle of the present disclosure can be used suitably for the purpose of viscosity control, can be reduced in particle size so that transparency might be good, and can be produced inexpensively.

### DETAILED DESCRIPTION OF PREFERRED EMBODIMENTS

In the following, the present disclosure is described in detail.

The crosslinked resin fine particle of the present disclosure is one obtained by reacting the above-described vinyl monomer composition essentially comprising the monomers (A) to (C) in an organic solvent. It is preferable that the organic solvent can dissolve all monomers and does not dissolve a polymer formed.

The polymer prepared using the (meth)acrylamide monomer (A) (hereinafter referred to as monomer (A)) and the crosslinkable unsaturated monomer (B) (hereinafter referred to as monomer (B)) cannot be formed easily into a crosslinked resin fine particle for viscosity control because it becomes difficult to control particle diameter due to flocculation as described above. The present disclosure was completed by finding that the use of the (meth)acrylate having an alkyl group containing 8 to 24 carbon atoms (C) (hereinafter referred to as monomer (C)) in a specific proportion together with the aforementioned monomers improves such a problem and the product can be used as a crosslinked resin fine particle for viscosity control.

The monomer (A) is a (meth)acrylamide monomer and is represented by the following general formula (1)

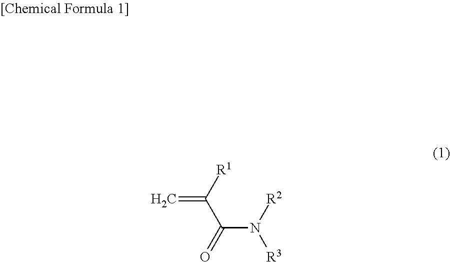

wherein R¹ represents a hydrogen atom or a methyl group, R² and R³ are the same or different and each represent a hydrogen atom or an alkyl group containing 1 to 5 carbon atoms.

The “alkyl group containing 1 to 5 carbon atoms” represented by R² or R³ in the formula (1) may be either straight or branched, and examples thereof include a methyl group, an ethyl group, a n-propyl group, an isopropyl group, a n-butyl group, an isobutyl group, a t-butyl group, and an amyl group. These compounds may be used either singly or in combination.

The monomer (A) is contained in a proportion of 5 to 50% by weight relative to the overall weight of the vinyl monomer composition to be used as a polymerization raw material. If the amount of the monomer (A) is less than 5% by weight, particles are not formed because of poor cohesion. If it exceeds 50% by weight, cohesion becomes excessively high, undesirably resulting in formation of association between particles.

The upper limit of the incorporated amount of the monomer (A) is more preferably 40% by weight, and even more preferably 35% by weight. The lower limit of the incorporated amount of the monomer (A) is more preferably 10% by weight, and even more preferably 15% by weight.

It is more preferable that the monomer (A) is at least one compound selected from the group consisting of (meth)acrylamide, N-methyl(meth)acrylamide, N-ethyl(meth)acrylamide, N-propyl(meth)acrylamide, N-butyl(meth)acrylamide, N,N-dimethyl(meth)acrylamide, N,N-diethyl(meth)acrylamide, N,N-dipropyl(meth)acrylamide, and N,N-dibutyl(meth)acrylamide.

The N-propyl(meth)acrylamide may be either N-n-propyl(meth)acrylamide or N-isopropyl(meth)acrylamide. The N-butyl(meth)acrylamide may be any of N-n-butyl(meth)acrylamide, N-sec-butyl(meth)acrylamide, N-isobutyl(meth)acrylamide, and N-t-butyl(meth)acrylamide. The propyl groups of N,N-dipropyl(meth)acrylamide may be the same or different and may be either a n-propyl group or an isopropyl group. The butyl groups in N,N-dibutyl(meth)acrylamide may be the same or different and may be any of a n-butyl group, a sec-butyl group, an isobutyl group, and a t-butyl group.

The monomer (B) is a component that contributes to crosslinking of particles and a compound having one or two, preferably one N-methylol group or N-alkoxymethyl group and one polymerizable double bond in one molecule. Among them, a compound represented by the following general formula (2) is particularly preferable.

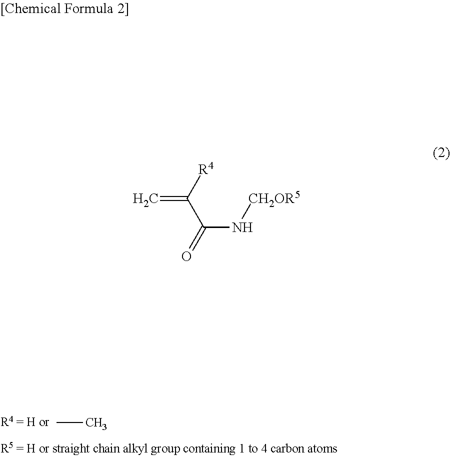

When R⁵ is H, the compound is N-methylol(meth)acrylamide, and when R⁵ is a straight chain alkyl group containing 1 to 4 carbon atoms, the compound is a N-alkoxymethyl(meth)acrylamide. N-methoxymethyl(meth)acrylamide, N-n-butoxymethyl(meth)acrylamide, etc. can be used suitably as the N-alkoxymethyl(meth)acrylamide. Two or more compounds selected from such compounds may be employed concurrently.

The monomer (B) may be one that forms a crosslinking chain via a condensation reaction which side chains undergo. Because of the use of this compound, a crosslinked resin fine particle can be obtained well via a reaction in an organic solvent.

The monomer (B) is incorporated in a proportion of 5 to 50% by weight relative to the overall weight of the vinyl monomer composition to be used as a polymerization raw material. If the amount is less than 5% by weight, problems will arise, for example, particles are swollen in a solvent due to a low crosslinking density, so that the particle diameter becomes coarse, or particles are dissolved in a coating solvent. If the amount exceeds 50% by weight, an interparticle crosslinking reaction proceeds, so that the polymerization system will gelate.

The upper limit of the amount of the monomer (B) is more preferably 40% by weight, and even more preferably 35% by weight. The lower limit of the amount of the monomer (B) is more preferably 10% by weight, and even more preferably 15% by weight.

In the present disclosure, a (meth)acrylate having an alkyl group containing 8 to 24 carbon atoms is used as an essential component as the monomer (C). By using the above-mentioned monomer (C) with other monomers, flocculation of particles can be inhibited due to the steric stabilization effect of an alkyl group, so that a minute crosslinked resin fine particle can be obtained.

Regarding the monomer (C), the (meth)acrylate having an alkyl group containing 8 to 24 carbon atoms is not particularly restricted and a variety of those known in the art of coating may be used. Specific examples thereof include nonyl(meth)acrylate, lauryl(meth)acrylate, cetyl(meth)acrylate, stearyl(meth)acrylate, and docosyl(meth)acrylate. Of these, one containing 10 to 20 carbon atoms is more preferable, and one having a straight alkyl group is even more preferable. One containing less than 8 carbon atoms will have poor ability to stabilize particles. Use of one containing more than 24 carbon atoms may cause serious deficiencies in external appearance due to flocculation formation caused by decrease in compatibility with a resin for a coating and decrease in dispersibility on the vaporization of a solvent.

The monomer (C) is preferably one to be incorporated in a proportion of 10 to 90% by weight relative to the overall weight of the vinyl monomer composition to be used as a polymerization raw material. If the amount is less than 10% by weight, the stabilization ability is poor, whereas if the amount exceeds 90% by weight, cohesion becomes weak, so that it becomes difficult to form a particle.

The upper limit of the amount of the monomer (C) is more preferably 70% by weight, and even more preferably 60% by weight. The lower limit of the amount of the monomer (C) is more preferably 20% by weight, and even more preferably 30% by weight.

The crosslinked resin particle of the present disclosure may be one obtained via a polymerization of a monomer composition containing, in addition to the above-described monomers (A), (B), and (C), other monomer (D).

Any known vinyl polymerizable monomer can be used as the other monomer (D).

Especially, a hydroxyl group-containing vinyl monomer (D-1) is preferably employed for part or all.

The use of the hydroxyl group-containing vinyl monomer (D-1) is favorable in that hydroxyl groups in a resin undergo a crosslinking reaction with the monomer (B), so that a crosslinked resin particle can be obtained efficiently.

The hydroxyl group-containing vinyl monomer (D-1) is not particularly restricted, and examples thereof include 2-hydroxylethyl(meth)acrylate, 4-hydroxybutyl(meth)acrylate, hydroxypropyl(meth)acrylate, and compounds obtained by ring-opening reaction of 2-hydroxyethyl(meth)acrylate by ε-caprolactone (PLACCEL FA series and FM series produced by DAICEL CHEMICAL INDUSTRIES, LTD.). These may be used either singly or in combination.

When the hydroxyl group-containing monomer (D-1) is used, the amount thereof is not particularly limited and, for example, it is preferably 0 to 15% by weight relative to the overall amount of the vinyl monomer composition. Adjustment to the range mentioned above is preferable in that the degree of crosslinking of a resin particle increases.

It is preferable to use a carboxylic acid group-containing monomer (D-2) as part or all of the other monomer (D). The use of the carboxylic acid group-containing monomer (D-2) as a catalyst for a condensation reaction of hydroxyl groups is preferable in that it can advance a crosslinking reaction efficiently. The carboxylic acid group-containing monomer (D-2) is not particularly restricted and examples thereof include (meth)acrylic acid, maleic acid, and itaconic acid.

When the carboxylic acid group-containing vinyl monomer (D-2) is used, the amount thereof is preferably 0 to 10% by weight relative to the overall amount of the vinyl monomer composition. Adjustment to the range mentioned above is preferable in that the above-described effects can be obtained well.

Monomers other than the hydroxyl group-containing vinyl monomer (D-1) and the carboxylic acid group-containing vinyl monomer (D-2) may also be used as the other monomer (D) and examples thereof include epoxy group-containing monomers such as glycidyl(meth)acrylate as well as methyl(meth)acrylate, ethyl(meth)acrylate, isopropyl(meth)acrylate, and styrene. The amount thereof is preferably 0 to 15% by weight. Moreover, a polyfunctional monomer such as divinylbenzene, ethylene glycol di(meth)acrylate, and trimethylolpropane tri(meth)acrylate may also be used. The amount of the polyfunctional monomer is preferably 0 to 10% by weight, and more preferably 0 to 5% by weight.

In the present disclosure, it is preferable to use substantially no highly hydrophilic monomer having a molecular weight of 400 or more. The use of such a highly hydrophilic monomer having a molecular weight of 400 or more is unfavorable in that the dispersibility in a solvent deteriorates remarkably, so that use of the monomer in a solvent-based coating may be impossible. Examples of monomers preferably not to be used include monoethylenic monomers having a polyoxyalkylene chain or a polyvinylpyrrolidone chain.

The crosslinked resin fine particle of the present disclosure is one obtained by reacting the above-described vinyl monomer composition in an organic solvent. It is preferable that the organic solvent can dissolve all monomers and does not dissolve a polymer formed. Therefore, an organic solvent may be chosen according to composition while taking into consideration the solubilities of the monomer to be used and the resin particle to be obtained. The organic solvent to be used is not particularly restricted, and examples thereof include ester type organic solvents such as ethyl acetate and butyl acetate; alcohol solvents such as ethanol, propanol, and butanol; ketone solvents such as methyl isobutyl ketone and diisobutyl ketone; ether solvents such as ethylcellosolve and ethyl-3-ethoxypropionate; and aliphatic hydrocarbon solvents such as cyclohexane and n-heptane. Moreover, a mixed solvent of two or more such solvents may be used. Furthermore, one containing some water may also be used. Since alcohol solvents may impair crosslinkability, secondary or tertiary alcohols are more preferable because of their low reactivity. Examples of such secondary alcohol solvents include isopropyl alcohol and propylene glycol monomethyl ether, and examples of such tertiary alcohol solvents include tertiary butyl alcohol.

In the production of the crosslinked resin fine particle of the present disclosure, it is preferable to use a radical polymerization initiator. Conventional ones may be used as the radical polymerization initiator and examples thereof include peroxides such as benzoyl peroxide, lauroyl peroxide, di-t-butyl peroxide, cumene hydroperoxide, t-butyl peroctoate, and t-butylperoxy 2-ethylhexanoate; azo compounds such as 2,2′-azobisisobutyronitrile, 2,2′-azobis(2,4-dimethylvaleronitrile), 2,2′-azobis(4-methoxy-2,4-dimethylvaleronitrile), dimethyl 2,2′-azobisisobutyrate, and 4,4′-azobis(4-cyanopentanoic acid); amidine compounds such as 2,2′-azobis(2-amidinopropane)dihydrochloride, 2,2′-azobis(N—N′-dimethyleneisobutylamidine), and 2,2′-azobis(N—N′-dimethyleneisobutylamidine)dihydrochloride; persulfide initiators such as potassium persulfate and ammonium persulfate or systems in which sodium hyposulfite, amine or the like are used therewith. Such initiators may be used singly or in combination. The usage amount thereof is usually adjusted to within the range of 0.2 to 5% by weight relative to the overall amount of monomers.

While the polymerization temperature may be varied depending upon the type of the polymerization initiator to be used, and so on, a temperature within the range of from about 50 to about 160° C., especially from 90 to 140° C., is usually appropriate, and the reaction time may be set to about 0.5 to about 10 hours. Adjustment of the polymerization temperature to 90° C. or higher allows intraparticle crosslinking of polymer particles to be advanced by a crosslinking reaction. When the polymerization temperature is lower than 90° C., since an intraparticle crosslinking reaction hardly proceeds during polymerization, it usually becomes necessary to perform operations of heating a formed polymer after the polymerization reaction at a temperature of 90° C. or more for 0.2 to 5 hours, thereby advancing the intraparticle crosslinking.

In order to advance the intraparticle crosslinking reaction of a polymer particle during the polymerization reaction or after the polymerization reaction more rapidly, a crosslinking reaction catalyst may be added to the polymerization system, if necessary. Examples of the crosslinking reaction catalyst include strong acid catalysts such as dodecylbenzenesulfonic acid and paratoluene sulfonic acid; and polymerizable double bond-containing strong acid catalysts such as sulfoethyl methacrylate.

A stabilizer is incorporated in polymerization in an organic solvent in cited document 1, etc. In the production of the crosslinked resin fine particle of the present disclosure, however, a stabilizer is not an essential ingredient because polymerization can be performed without using such a stabilizer.

The crosslinked resin fine particle of the present disclosure preferably has a number average particle diameter of 10 to 250 nm when being used for a color coating. Adjustment to within such a range makes the fine particle capable of being used as a good viscosity controlling agent when being used as a coating additive. That the number average particle diameter is less than 10 nm is undesirable because production is difficult, and that the number average particle diameter exceeds 250 nm is also undesirable because viscosity controlling ability declines. In the case where the transparency of a coating film is required, such as the case of use for viscosity control of a clear coating, it is preferable to adjust the number average particle diameter to 100 nm or less, more preferably to 50 nm or less. In the present specification, the number average particle diameter is a value measured by a light scattering method.

The crosslinked resin fine particle of the present disclosure can be employed, for example, for a viscosity controlling agent for a coating, an abrasion resistance, scratch resistance improver, a filler for optical film, and a filler for optical material.

The crosslinked resin fine particle of the present disclosure can be used as a viscosity controlling agent in a coating as described above, and a coating composition containing the crosslinked resin fine particle of the present disclosure is also one aspect of the present disclosure. Such a coating composition is not particularly restricted, and it can be used suitably in a solvent-based clear coating, a solvent-based colorant-containing base coating, and the like.

The solvent-based clear coating is not particularly restricted and examples thereof include coating compositions containing a hydroxyl group-containing acrylic resin and a curing agent such as a polyisocyanate compound and a melamine resin.

Preferably the crosslinked resin fine particle is contained in such a coating composition in a proportion of 0.5 to 15% by weight relative to the overall amount of the coating solid. Adjustment to within this range is favorable in that it allows the coating composition to develop a desired viscosity behavior and it demonstrates effects, for example, in prevention of sagging at the time of coating.

### EXAMPLES

Hereinafter, the present disclosure will be described in more detail by way of examples, but the invention is not limited only to the examples. In the examples, “part” and “%” mean “weight part” and “% by weight,” respectively, unless otherwise specified.

### Example 1

To a 1-L separable flask equipped with a reflux condenser, a stirring blade, a temperature controller, a nitrogen inlet, and a dropping funnel were charged 173.0 g of butyl acetate and 173.0 g of propylene glycol monomethyl ether. Subsequently, a mixed liquid (1) of 40.0 g of acrylamide, 30.0 g of N-methylolacrylamide, 20.0 g of hydroxyethyl acrylate, 10.0 g of acrylic acid, 85.0 g of propylene glycol monomethyl ether and a mixed liquid (2) of 100.0 g of nonyl methacrylate and 250.0 g of butyl acetate were prepared.

A reactor was charged with 0.6 g of azobisisobutyronitrile, 18.5 of the mixed liquid (1), and 35.0 g of the mixed liquid (2), and then the temperature was raised to 120° C. over about 30 minutes. After the reaction was continued for 30 minutes, dropping funnels respectively containing 166.5 g of the mixed liquid (1) and 315.0 g of the mixed liquid (2) containing 2.0 g of azobisisobutyronitrile dissolved therein were fitted to the reactor, and the mixed liquids were added dropwise over 3 hours. After the addition, the temperature was maintained for 1 hour and then cooled.

### Examples 2 to 15, Comparative Examples 1 to 8, 10 to 16

According to the compositions given in Tables 1 to 3, crosslinked resin particles were synthesized by the same procedure as that of Example 1.

### Comparative Example 9

A crosslinked resin particle was synthesized by the same procedure as that of Example 5 of JP-A-8-3251.

### (Measurement of Number Average Particle Diameter)

Measurement was conducted by a dynamic light scattering method (FPAR-1000 available from Otsuka Electronics Co., Ltd.) and then the value of number average particle diameter determined from light scatter intensity was used.

### (Preparation of Clear Coating)

A clear coating was prepared according to the following composition.

| | |
|---|---|
| ACS-1145 | 76.6 g |
| (produced by Nippon Paint Co., Ltd.) | |
| Sumidule N3300 | 28.3 g |
| (produced by Sumitomo Bayer Urethane Co. Ltd.) | |
| Butyl acetate | 26.1 g |
| Ethyl acetate | 8.3 g |
| Ethyl 3-ethoxypropionate | 17.6 g |
| Resin particle dispersion of Example/Comparative Example | 6.0 g |
| (solid fraction = 22.6%) | |

### (Evaluation of Dispersibility in Clear Coating)

The development of crude particles after the incorporation of the fine particle of Example/Comparative Example to the above-described clear coating was evaluated by grind gauge. One having a particle size of a crude particle of 5 μm or less is represented by 0, and one having a particle size of a crude particle exceeding 5 μm is represented by x.

### (Evaluation of Sagging Prevention Ability of Clear Coating)

A planar polypropylene substrate with a hole being 5 mm in diameter was held vertically. A primer RB116 produced by Nippon Bee Chemical Co., Ltd. was applied thereon in a dry film thickness of 10 μm and then left at rest at room temperature for 5 minutes, and further a base coating R-301 produced by Nippon Bee Chemical Co., Ltd. was applied in a dry film thickness of 15 μm and then left at rest for 5 minutes. Subsequently, a prepared clear coating was applied in a film thickness of 40 μm, left at rest at room temperature for 5 minutes, and then dried at 120° C. for 20 minutes.

Thereafter, the external appearance was observed. The case where no sagging was observed is represented by 0, the case where sagging was less than 4 mm in length is represented by 0, and the case where sagging of 4 mm or more in length was observed is represented by x.

### (Evaluation of Transparency of Clear Coating)

The above-described clear coating was applied to a 1 mm thick polycarbonate substrate in a dry film thickness of 30 μm, left at rest at room temperature for 5 minutes, and dried at 120° C. for 20 minutes.

After cooling, a haze value was measured with a haze mater, and a haze value of less than 0.5 is represented by ◯, a haze value of not less than 0.5 and less than 1.0 is represented by Δ, and a haze value of not less than 1.0 is represented by x.

### (Preparation of Color Coating)

Abase coating was prepared by the following composition.

| | |
|---|---|
| Mixed liquid of CAB-531-1/butyl acetate/methyl ethyl | 3.20 g |
| ketone =20/70/10 | |
| (CAB-531-1 produced by Eastman Chemical Co.) | |
| Duranate MF-K 60X | 5.60 g |
| (produced by Asahi Kasei Corporation) | |
| DISPARLON 4200-10 | 2.27 g |
| (produced by Kusumoto Chemicals, Ltd.) | |
| COATAX A-200 | 31.60 g |
| (acrylic resin produced by Toray Fine Chemicals Co., Ltd.) | |
| IB-6600 | 1.60 g |
| (polyether polyol produced by Sanyo Chemical Industries, | |
| Ltd.) | |
| Alpaste 65-388N | 7.01 g |
| (produced by Toyo Aluminium K.K.) | |
| ACS-1016 | 0.34 g |
| (acrylic resin produced by Nippon Paint Co., Ltd.) | |
| Ethyl acetate | 13.66 g |
| Butyl acetate | 10.00 g |
| Isobutanol | 2.50 g |
| Xylene | 11.02 g |
| Resin particle of Example/Comparative Example (on the | 2.14 g |
| solid matter basis) | |

### (Evaluation of Dispersibility in Color Coating)

The fine particle of Examples and Comparative Examples was mixed and then filtered with Yoshino paper. The case where the fine particle passed through completely is represented by ◯, and the case where some aggregated matter remained on the paper is represented by x.

### (Evaluation of Sagging Prevention Ability of Color Coating)

A planar polypropylene substrate with a hole being 5 mm in diameter was held vertically. A primer RB116 produced by Nippon Bee Chemical Co., Ltd. was applied thereon in a dry film thickness of 10 μm and then left at rest at room temperature for 5 minutes, and further the base coating was applied in a dry film thickness of 25 μm and then left at rest for 5 minutes. Thereafter, the external appearance was observed. The case where no sagging was observed is represented by ⊙, the case where sagging was less than 4 mm in length is represented by ◯, and the case where sagging of 4 mm or more in length was observed is represented by x.

These evaluation results are shown in Tables 1 to 3 provided below.

TABLE 1

| | | | | | Comparative | Comparative | Comparative | | | Comparative |
|---|---|---|---|---|---|---|---|---|---|---|
| | Example 1 | Example 2 | Example 3 | Example 4 | Example 1 | Example 2 | Example 3 | Example 5 | Example 6 | Example 4 |
| Acrylamide | 20.0 | 20.0 | 20.0 | 20.0 | 20.0 | 20.0 | 20.0 | 20.0 | 12.0 | 2.0 |
| N- | 15.0 | 15.0 | 15.0 | 15.0 | 15.0 | 15.0 | 15.0 | 15.0 | 9.0 | 2.0 |
| methylolacrylamide | | | | | | | | | | |
| Hydroxyethyl | 10.0 | 10.0 | 10.0 | 10.0 | 10.0 | 10.0 | 10.0 | 10.0 | 6.0 | 0.5 |
| acrylate | | | | | | | | | | |
| Acrylic acid | 5.0 | 5.0 | 5.0 | 5.0 | 5.0 | 5.0 | 5.0 | 5.0 | 3.0 | 0.5 |
| Nonyl methacrylate | 50.0 | | | | | | | | | |
| Lauryl methacrylate | | 50.0 | | | | | 5.0 | 30.0 | 70.0 | 95.0 |
| Stearyl acrylate | | | 50.0 | | | | | | | |
| Docosyl acrylate | | | | 50.0 | | | | | | |
| Hexacosyl | | | | | 50.0 | | | | | |
| methacrylate | | | | | | | | | | |
| Hexyl acrylate | | | | | | 50.0 | 45.0 | 20.0 | | |
| Total of monomers | 100.0 | 100.0 | 100.0 | 100.0 | 100.0 | 100.0 | 100.0 | 100.0 | 100.0 | 100.0 |
| Number average | 32.2 | 21.9 | 20.4 | 19.3 | 21.5 | 276.4 | 268.5 | 64.4 | 33.7 | No particle |
| particle diameter | | | | | | | | | | was formed. |
| (nm) | | | | | | | | | | |

Evaluation of clear coating

| | | | | | | | | | | |
|---|---|---|---|---|---|---|---|---|---|---|
| Dispersibility in | ◯ | ◯ | ◯ | ◯ | X | ◯ | ◯ | ◯ | ◯ | Not |
| coating | | | | | | | | | | evaluated |
| Sagging prevention | ⊙ | ⊙ | ⊙ | ⊙ | X | X | X | ⊙ | ⊙ | Not |
| ability | | | | | | | | | | evaluated |
| Transparency | ◯ | ◯ | ◯ | ◯ | X | X | X | Δ | ◯ | Not |
| | | | | | | | | | | evaluated |

Evaluation of color coating

| | | | | | | | | | | |
|---|---|---|---|---|---|---|---|---|---|---|
| Dispersibility in | ◯ | ◯ | ◯ | ◯ | X | ◯ | ◯ | ◯ | ◯ | Not |
| coating | | | | | | | | | | evaluated |
| Sagging prevention | ⊙ | ⊙ | ⊙ | ⊙ | X | X | X | ⊙ | ⊙ | Not |
| ability | | | | | | | | | | evaluated |

TABLE 2

| | Comparative | | | Comparative | Comparative | | Example | Comparative | Comparative |
|---|---|---|---|---|---|---|---|---|---|
| | Example 5 | Example 7 | Example 8 | Example 6 | Example 7 | Example 9 | 10 | Example 8 | Example 9 |
| Acrylamide | 4.0 | 8.0 | 44.0 | 55.0 | 36.0 | 32.0 | 16.0 | 12.0 | Replication |
| N-methylolacrylamide | 36.0 | 32.0 | 16.0 | 12.0 | 4.0 | 8.0 | 44.0 | 55.0 | of Example 5 |
| Hydroxyethyl acrylate | 5.0 | 5.0 | 5.0 | 0.0 | 5.0 | 5.0 | 5.0 | 0.0 | of |
| Acrylic acid | 5.0 | 5.0 | 5.0 | 3.0 | 5.0 | 5.0 | 5.0 | 3.0 | JP-A-8-3251 |
| Nonyl methacrylate | | | | | | | | | |
| Lauryl methacrylate | 50.0 | 50.0 | 30.0 | 30.0 | 50.0 | 50.0 | 30.0 | 30.0 | |
| Stearyl acrylate | | | | | | | | | |
| Docosyl acrylate | | | | | | | | | |
| Hexacosyl methacrylate | | | | | | | | | |
| Hexyl acrylate | | | | | | | | | |
| Total of monomers | 100.0 | 100.0 | 100.0 | 100.0 | 100.0 | 100.0 | 100.0 | 100.0 | |
| Number average particle | No particle | 35.5 | 84.5 | Interparticle | 454.6 | 28.5 | 87.2 | Gelation | 74.0 |
| diameter (nm) | was formed. | | | cohesion | | | | | |

Evaluation of clear coating

| | | | | | | | | | |
|---|---|---|---|---|---|---|---|---|---|
| Dispersibility in coating | Not | ◯ | ◯ | Not evaluated | ◯ | ◯ | ◯ | Not | X |
| | evaluated | | | | | | | evaluated | |
| Sagging prevention | Not | ⊙ | ⊙ | Not evaluated | X | ⊙ | ⊙ | Not | X |
| ability | evaluated | | | | | | | evaluated | |
| Transparency | Not | ◯ | Δ | Not evaluated | X | ◯ | Δ | Not | X |
| | evaluated | | | | | | | evaluated | |

Evaluation of color coating

| | | | | | | | | | |
|---|---|---|---|---|---|---|---|---|---|
| Dispersbility in coating | Not | ◯ | ◯ | Not evaluated | ◯ | ◯ | ◯ | Not | X |
| | evaluated | | | | | | | evaluated | |
| Sagging prevention | Not | ⊙ | ⊙ | Not evaluated | X | ⊙ | ⊙ | Not | X |
| ability | evaluated | | | | | | | evaluated | |

TABLE 3

| | | | | Compara- | Compara- | | | Compara- | Compara- | Compara- | Compara- | Compara- |
|---|---|---|---|---|---|---|---|---|---|---|---|---|
| | Exam- | Exam- | Exam- | tive | tive | Exam- | Exam- | tive | tive | tive | tive | tive |
| | ple | ple | ple | Example | Example | ple | ple | Example | Example | Example | Example | Example |
| | 11 | 12 | 13 | 10 | 11 | 14 | 15 | 12 | 13 | 14 | 15 | 16 |
| Acrylamide | 20.0 | 20.0 | 25.0 | 25.0 | 25.0 | 25.0 | 15.0 | 12.0 | 58.0 | 2.5 | 4.0 | 46.0 |
| N-methylolacryl- | 20.0 | 25.0 | 25.0 | 25.0 | 25.0 | 25.0 | 15.0 | 58.0 | 12.0 | 2.5 | 46.0 | 4.0 |
| amide | | | | | | | | | | | | |
| Hydroxyethyl | 10.0 | | | | | | | | | | | |
| acrylate | | | | | | | | | | | | |
| Acrylic acid | | 5.0 | | | | | | | | | | |
| Nonyl | | | | | | | | | | | | |
| methacrylate | | | | | | | | | | | | |
| Lauryl | 50.0 | 50.0 | 50.0 | | | 30.0 | 70.0 | 30.0 | 30.0 | 95.0 | 50.0 | 50.0 |
| methacrylate | | | | | | | | | | | | |
| Stearyl acrylate | | | | | | | | | | | | |
| Docosyl acrylate | | | | | | | | | | | | |
| Hexacosyl | | | | 50.0 | | | | | | | | |
| methacrylate | | | | | | | | | | | | |
| Hexyl acrylate | | | | | 50.0 | 20.0 | | | | | | |
| Total of | 100.0 | 100.0 | 100.0 | 100.0 | 100.0 | 100.0 | 100.0 | 100.0 | 100.0 | 100.0 | 100.0 | 100.0 |
| monomers | | | | | | | | | | | | |
| Number average | 26.2 | 36.8 | 45.7 | 42.5 | 312.2 | 94.7 | 29.5 | Gelation | Inter- | No | No | 522.7 |
| particle | | | | | | | | | particle | particle | particle | |
| diameter (nm) | | | | | | | | | cohesion | was | was | |
| | | | | | | | | | | formed. | formed. | |

Evaluation of clear coating

| | | | | | | | | | | | | |
|---|---|---|---|---|---|---|---|---|---|---|---|---|
| Dispersibility in | ◯ | ◯ | ◯ | X | ◯ | ◯ | ◯ | Not | Not | Not | Not | ◯ |
| coating | | | | | | | | evaluated | evaluated | evaluated | evaluated | |
| Sagging | ◯ | ◯ | ◯ | X | X | ◯ | ◯ | Not | Not | Not | Not | X |
| prevention ability | | | | | | | | evaluated | evaluated | evaluated | evaluated | |
| Transparency | ◯ | ◯ | ◯ | X | X | Δ | ◯ | Not | Not | Not | Not | X |
| | | | | | | | | evaluated | evaluated | evaluated | evaluated | |

Evaluation of color coating

| | | | | | | | | | | | | |
|---|---|---|---|---|---|---|---|---|---|---|---|---|
| Dispersibility in | ◯ | ◯ | ◯ | X | ◯ | ◯ | ◯ | Not | Not | Not | Not | ◯ |
| coating | | | | | | | | evaluated | evaluated | evaluated | evaluated | |
| Sagging | ◯ | ◯ | ◯ | X | X | ◯ | ◯ | Not | Not | Not | Not | X |
| prevention ability | | | | | | | | evaluated | evaluated | evaluated | evaluated | |

The results disclosed in Tables 1 to 3 show that the crosslinked resin fine particles of the present disclosure have excellent characteristics in compatibility with resin and sagging prevention ability.

### Example 16

To a 1-Liter separable flask equipped with a reflux condenser, a stirring blade, a temperature controller, a nitrogen inlet, and a dropping funnel were charged 140.0 g of butyl acetate and 140.0 g of propylene glycol monomethyl ether. Subsequently, a mixed liquid (1) of 60.0 g of acrylamide, 45.0 g of N-methylolacrylamide, 30.0 g of hydroxyethyl acrylate, 15.0 g of acrylic acid, and 100.0 g of propylene glycol monomethyl ether and a mixed liquid (2) of 150.0 g of lauryl methacrylate and 200.0 g of butyl acetate were prepared.

A reactor was charged with 0.9 g of azobisisobutyronitrile, 25.0 g the mixed liquid (1), and 35.0 g of the mixed liquid (2), and then the temperature was raised to 120° C. over about 30 minutes. After the reaction was continued for 30 minutes, dropping funnels respectively containing 225.0 g of the mixed liquid (1) and 315.0 g of the mixed liquid (2) containing 3.0 g of azobisisobutyronitrile dissolved therein were fitted to the reactor, and the mixed liquids were added dropwise over 3 hours.

After the addition, the temperature was maintained for 1 hour and then cooled.

### Examples 17 to 23, Comparative Examples 17 to 25

A crosslinked resin particle was synthesized by the same procedure as that of Example 16.

### Comparative Example 26

A crosslinked resin particle was synthesized by the same procedure as that of Example 2 of JP-A-8-3251.

### (Measurement of Particle Diameter)

Measurement was conducted by a dynamic light scattering method (FPAR-1000 produced by Otsuka Electronics Co., Ltd.) and then the value of number average particle diameter determined from light scatter intensity was used.

### (Preparation of Color Coating)

A color coating was prepared in the same way as described above, followed by the same evaluation as described above.

Results are shown in Tables 4 and 5.

TABLE 4

| | Example | Example | Example | Example | Comparative | Comparative | Comparative | Comparative | Example | Example |
|---|---|---|---|---|---|---|---|---|---|---|
| | 16 | 17 | 18 | 19 | Example 17 | Example 18 | Example 19 | Example 20 | 20 | 21 |
| Acrylamide | 20.0 | 20.0 | 20.0 | 25.0 | 20.0 | 20.0 | 25.0 | 25.0 | 20.0 | 12.0 |
| N- | 15.0 | 20.0 | 25.0 | 25.0 | 15.0 | 15.0 | 25.0 | 25.0 | 15.0 | 9.0 |
| methylolacrylamide | | | | | | | | | | |
| Hydroxyethyl | 10.0 | 10.0 | | | 10.0 | 10.0 | | | 10.0 | 6.0 |
| acrylate | | | | | | | | | | |
| Acrylic acid | 5.0 | | 5.0 | | 5.0 | 5.0 | | | 5.0 | 3.0 |
| Nonyl methacrylate | | | | | | | | | | |
| Lauryl methacrylate | 50.0 | 50.0 | 50.0 | 50.0 | | | | | 30.0 | 70.0 |
| Stearyl acrylate | | | | | | | | | | |
| Docosyl acrylate | | | | | | | | | | |
| Hexacosyl | | | | | 50.0 | | 50.0 | | | |
| methacrylate | | | | | | | | | | |
| Hexyl acrylate | | | | | | 50.0 | | 50.0 | 20.0 | |
| Total of monomers | 100.0 | 100.0 | 100.0 | 100.0 | 100.0 | 100.0 | 100.0 | 100.0 | 100.0 | 100.0 |
| Number average | 143.2 | 167.3 | 185.7 | 217.9 | 122.7 | 355.7 | 213.3 | 472.3 | 197.6 | 140.6 |
| particle diameter | | | | | | | | | | |
| (nm) | | | | | | | | | | |
| Dispersibility in | ◯ | ◯ | ◯ | ◯ | X | ◯ | X | ◯ | ◯ | ◯ |
| coating | | | | | | | | | | |
| Sagging prevention | ⊙ | ◯ | ◯ | ◯ | X | X | X | X | ⊙ | ⊙ |
| ability | | | | | | | | | | |

TABLE 5

| | Example | Example | Comparative | Comparative | Comparative | Comparative | Comparative | Comparative |
|---|---|---|---|---|---|---|---|---|
| | 22 | 23 | Example 21 | Example 22 | Example 23 | Example 24 | Example 25 | Example 26 |
| Acrylamide | 25.0 | 15.0 | 12.0 | 58.0 | 2.5 | 4.0 | 46.0 | Replication |
| N-methylolacrylamide | 25.0 | 15.0 | 58.0 | 12.0 | 2.5 | 46.0 | 4.0 | of Example 2 |
| Hydroxyethyl acrylate | | | | | | | | of |
| Acrylic acid | | | | | | | | JP-A-8-3251 |
| Nonyl methacrylate | | | | | | | | |
| Lauryl methacrylate | 30.0 | 70.0 | 30.0 | 30.0 | 95.0 | 50.0 | 50.0 | |
| Stearyl acrylate | | | | | | | | |
| Docosyl acrylate | | | | | | | | |
| Hexacosyl | | | | | | | | |
| methacrylate | | | | | | | | |
| Hexyl acrylate | 20.0 | | | | | | | |
| Total of monomers | 100.0 | 100.0 | 100.0 | 100.0 | 100.0 | 100.0 | 100.0 | |
| Number average | 242.5 | 172.5 | Gelation | Interparticle | No particle | No particle | 774.2 | 330.2 |
| particle diameter (nm) | | | | cohesion | was formed. | was formed. | | |
| Dispersibility in | ◯ | ◯ | Not | Not evaluated | Not | Not | ◯ | X |
| coating | | | evaluated | | evaluated | evaluated | | |
| Sagging prevention | ◯ | ◯ | Not | Not evaluated | Not | Not | X | X |
| ability | | | evaluated | | evaluated | evaluated | | |

The results of Tables 4 and 5 show that the crosslinked resin fine particles of the present disclosure of Examples 17 to 24 have excellent characteristics in dispersibility into resin and sagging prevention ability.

### INDUSTRIAL APPLICABILITY

The crosslinked resin fine particle of the present disclosure can be used for a variety of applications, and it can be used suitably as, especially, a viscosity controlling agent for coating.

1. Crosslinked resin fine particles obtained by reacting a vinyl monomer composition comprising
5 to 50% by weight of a (meth)acrylamide-based monomer (A),
5 to 50% by weight of a crosslinkable unsaturated monomer (B), and
10 to 90% by weight of a (meth)acrylate having an alkyl group containing 8 to 24 carbon atoms (C) in an organic solvent, and
having a number average particle diameter of 10 to 250 nm.

2. The crosslinked resin fine particle according to claim 1, wherein the (meth)acrylamide-based monomer (A) is at least one monomer selected from the group consisting of (meth)acrylamide, N-methyl(meth)acrylamide, N-ethyl(meth)acrylamide, N-propyl(meth)acrylamide, and N-butyl(meth)acrylamide.

3. The crosslinked resin fine particle according to claim 1, wherein the crosslinkable unsaturated monomer (B) is at least one monomer selected from the group consisting of N-methylol(meth)acrylamide and N-alkoxymethyl(meth)acrylamide.

4. The crosslinked resin fine particle according to claim 1, wherein the (meth)acrylate (C) is at least one monomer selected from compounds having a linear alkyl group containing 10 to 20 carbon atoms.

5. The crosslinked resin fine particle according to claim 1, wherein the vinyl monomer composition further comprises a monomer (D) other than the (A), the (B), and the (C).

6. The crosslinked resin fine particle according to claim 5, wherein the vinyl monomer composition comprises a hydroxyl group-containing vinyl monomer (D-1) as the monomer (D) other than the (A), the (B), and the (C).

7. The crosslinked resin fine particle according to claim 5, wherein the vinyl monomer composition comprises a carboxylic acid group-containing vinyl monomer (D-2) as the monomer (D) other than the (A), the (B), and the (C).

8. A coating composition comprising the crosslinked resin fine particle according to claim 1.

9. A coating composition comprising the crosslinked resin fine particle according to claim 5.
